(19) United States
(12) Patent Application Publication
(10) Pub. No.: US 2025/0344185 A1
(43) Pub. Date: Nov. 6, 2025

(54) PEI INDICATION OF COMMON SIGNALS AND CHANNELS UPDATE

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 18/655,130

(22) Filed: May 3, 2024

(51) Int. Cl. H04W 68/00

(52) U.S. Cl. CPC H04W 68/005

(57) ABSTRACT

This disclosure provides approaches for the adaptation of common signal and channel transmissions indicated through paging early indications (PEIs) in wireless networks. The disclosed methods and apparatuses allow for improved energy efficiency through on-demand operations and the use of PEIs in the management of paging occasions and signal configurations. Methods of wireless communication performable at a user equipment (UE) are accordingly provided which allow the UE to obtain a PEI indicating a paging occasion (PO), the PEI further indicating a presence or absence of an updated configuration for a common signal or a common channel, monitor the PO based on the PEI, and receive the updated configuration in the PO or in the PEI in response to the monitoring. This approach allows for efficient monitoring and receiving of updated configurations for common signals or channels, thereby improving the efficiency of the communication process and saving network energy.

### TECHNICAL FIELD

The present disclosure generally pertains to the field of wireless communication, and more particularly, to the adaptation of common signal and channel transmissions indicated through Paging Early Indications (PEIs).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to obtain a paging early indication (PEI) indicating a paging occasion (PO), the PEI further indicating a presence or absence of an updated configuration for a common signal or a common channel, to monitor the PO based on the PEI, to receive the updated configuration in the PO or in the PEI in response to the monitoring.

Another innovative aspect of the subject matter described in this disclosure may be implemented in a method for wireless communication performable at a UE. The method includes obtaining a PEI indicating a PO, the PEI further indicating a presence or absence of an updated configuration for a common signal or a common channel, monitoring the PO based on the PEI, and receiving the updated configuration in the PO or in the PEI in response to the monitoring.

Another innovative aspect of the subject matter described in this disclosure may be implemented in an apparatus for wireless communication, which may be a UE. The apparatus includes means for obtaining a PEI indicating a PO, the PEI further indicating a presence or absence of an updated configuration for a common signal or a common channel, means for monitoring the PO based on the PEI, and means for receiving the updated configuration in the PO or in the PEI in response to the monitoring.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a block diagram illustrating an example of paging frames that include synchronization signal blocks (SSBs) and paging occasions (POs).

FIG. 5 is a block diagram illustrating an example of paging frames that include POs indicated in a paging early indication (PEI).

FIG. 6 is a block diagram illustrating an example of an indication in PEI of a PO for a subgroup of UEs.

FIG. 7 is a block diagram illustrating an example of PEI that is applied to inform UEs associated with POs about upcoming adaptations in common signals and channels.

FIG. 8 is a flowchart illustrating an example of UE behavior in response to receiving PEI including an adaptation indication.

FIG. 9 is a diagram illustrating an example of a call flow between a base station and a UE.

FIG. 10 is a flowchart of an example method of wireless communication performable at a UE.

FIG. 11 is a diagram illustrating an example of a hardware implementation for an apparatus that is a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Studies have been conducted on network energy savings, focusing on various aspects such as on-demand synchronization signal blocks (SSBs), on-demand system information block 1s (SIB1s), wake-up signal triggers, backhaul signaling, activation signaling, and the like. A goal of these studies is to decrease the number of common signals or channels that a user equipment (UE) receives. For instance, a Release 19 network energy saving project aims to investigate the potential dynamic adaptation of SSBs and the Physical Random Access Channel (PRACH) in the time domain. This may be performed with the intention of enhancing energy efficiency in 5G networks.

SSB and PRACH are common signals or channels, and thus they are utilized by multiple UEs within a network. As a result, signaling an adaptation of SSBs or PRACH in a group common manner, such as an update to their timing or other parameters, is energy-efficient. This is because one signal may be used to communicate the adaptation to multiple UEs, instead of sending individual signals to each UE. At present, the adaptation of common signals or channels, such as SSBs, PRACH, and paging occasions, is carried out through a SIB1. However, SIB1s may be transmitted at a high frequency, for instance, every 160 milliseconds. This timing for updates may occasionally not align well with traffic conditions. Furthermore, if the SIB1 itself is updated, the UE may not be able to decode the SIB1 without some indication of the change, such as through paging.

Therefore, it would be helpful to use paging to adapt common signals or channels in a cellular network. However, this approach presents certain challenges. On one hand, if a paging indication, downlink control information (DCI), and a related paging occasion are applied to signal the adaptation, then there may be sufficient payload to provide the adaptation information. However, each paging occasion is associated with its own UE or SSB, and multiple UEs may be linked with different paging occasions in a paging frame and different paging frames in a discontinuous reception (DRX) cycle. Thus, the base station or core network may end up sending such adaptation in every single one of these paging occasions and every single one of these paging frames to inform every UE about the adaptation, which is highly inefficient. On the other hand, while a paging early indicator (PEI) may be used to send fewer signals than the PO, the PEI does not have the payload to indicate the adaptation information and so it cannot carry much information for this purpose.

Consequently, the present disclosure aims to enhance the energy efficiency of networks by providing for adaptation of common signals or channels, such as SSBs and PRACH, using PEI to signal these adaptations. The network leverages the efficiency advantage of the PEI, which is sent before all the paging occasions, to indicate that an adaptation is forthcoming, while the actual indication of the adaptation itself may be performed using the paging occasions signaled by the PEI. As an example, the PEI may indicate the presence or absence of an adaptation of a common signal and channel, as well as paging occasion information sent in a given PEI, while the paging occasions themselves may include the adaption information such as the updated timing of the SSB, PRACH, or other common signal or channel. As a result, UEs may monitor a single PEI to determine whether or not to monitor an associated paging occasion for the adaptation, rather than requiring the base station to send adaption signals in every paging occasion. Thus, the PEI may inform UEs about upcoming adaptations in common signals and channels, improving energy efficiency in cellular networks.

Accordingly, various aspects of the subject matter described in this disclosure relate generally to wireless communication and more particularly to the adaptation of common signal and channel transmissions indicated through PEIs. Various aspects specifically relate to strategies for indicating which paging occasion may carry the adaptation of the common signal or channel. In one example, when the base station sends a SIB1 or other system information, it may indicate in its configuration that a PO, for example an initial PO or another one, will carry the adaptation that is indicated in the PEI. In another example, rather than the SIB1 or system information indicating the PO(s) containing the adaptation, the PEI itself may indicate the PO(s) containing the adaptation, for example using an additional bitmap or another method. In yet another example, neither the SIB1 nor the PEI indicates the PO(s) containing the adaptation. Instead, there may be a fixed behavior the UE applies in which, if the PEI indicates there is a paging, then the UE will monitor whatever paging occasion is indicated for the sent adaptation. If there is not any paging for that UE, for example, if a PEI bitmap includes all zeros, but there is an indication in the PEI that there is an adaptation, then the UE may fall back to one of the aforementioned other examples for determining adaptation accordingly. In other examples, apparatuses and methods are also provided in which a UE monitors specific POs based on the PEI, and receives updated configurations for common signals or channels in these POs or the PEI, thereby improving the efficiency of the communication process and saving network energy. This includes the use of different DCI formats to distinguish PEIs that include updated configuration information from other PEIs that do not, allowing the network to communicate updated configuration information to the UE in a way that is distinct from other types of information.

Thus, particular aspects of the subject matter described in this disclosure may be implemented to realize one or more potential advantages. For example, the described methods and apparatuses may improve the efficiency of communication in 5G networks and save energy by managing the transmission of common signals and channels based on demand and adapting their transmissions. This may be achieved by using PEIs to guide UEs explicitly or implicitly to the correct POs to receive updated configurations, and by transmitting these configurations along with paging messages in the same PO or a different indicated PO. Other advantages relate to improving the clarity of communication between the network and the UE. For example, using different DCI formats to distinguish PEIs that include updated configuration information from other PEIs that do not, allows the network to communicate updated configuration information to the UE in a way that is distinct from other types of information.

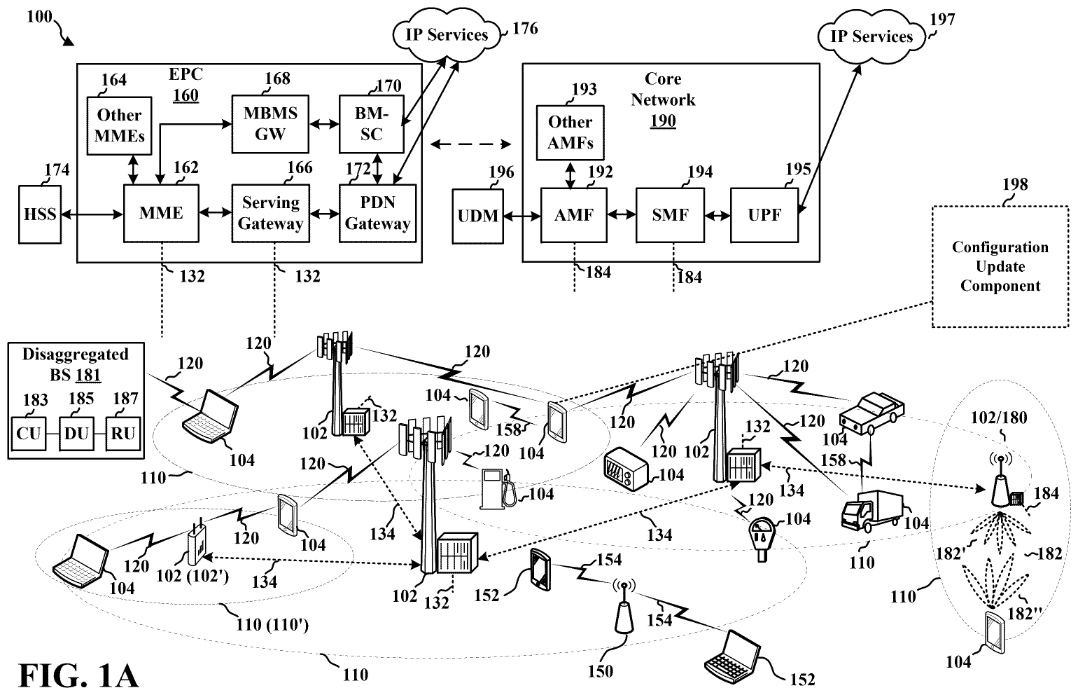

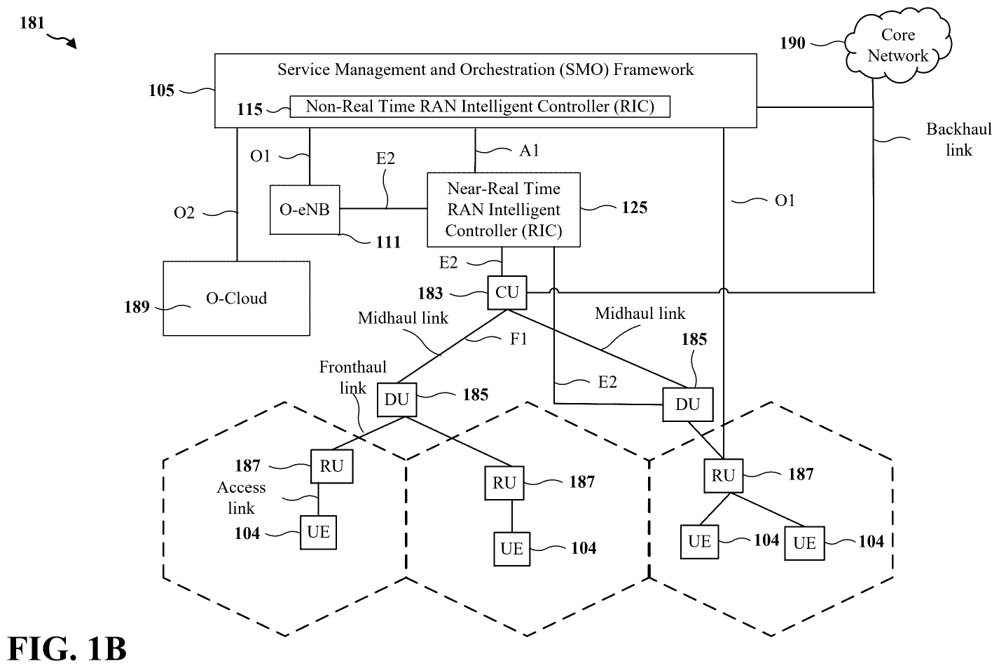

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may include a configuration update component 198 that is configured to obtain a paging early indication (PEI) indicating a paging occasion (PO), the PEI further indicating a presence or absence of an updated configuration for a common signal or a common channel, monitor the PO based on the PEI, and receive the updated configuration in the PO or in the PEI in response to the monitoring. The UE may obtain the PEI and receive the updated configuration from base station 102/180, disaggregated base station 181, a component of disaggregated base station 181 such as CU 183, DU 185, or RU 187, or some other network entity.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

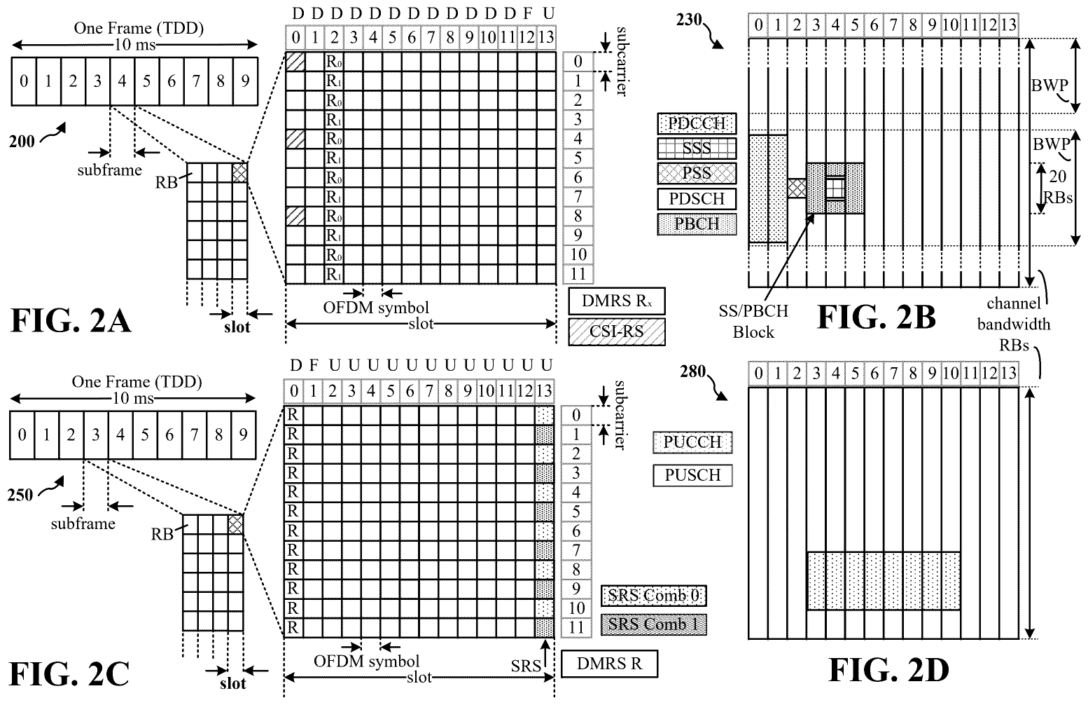

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

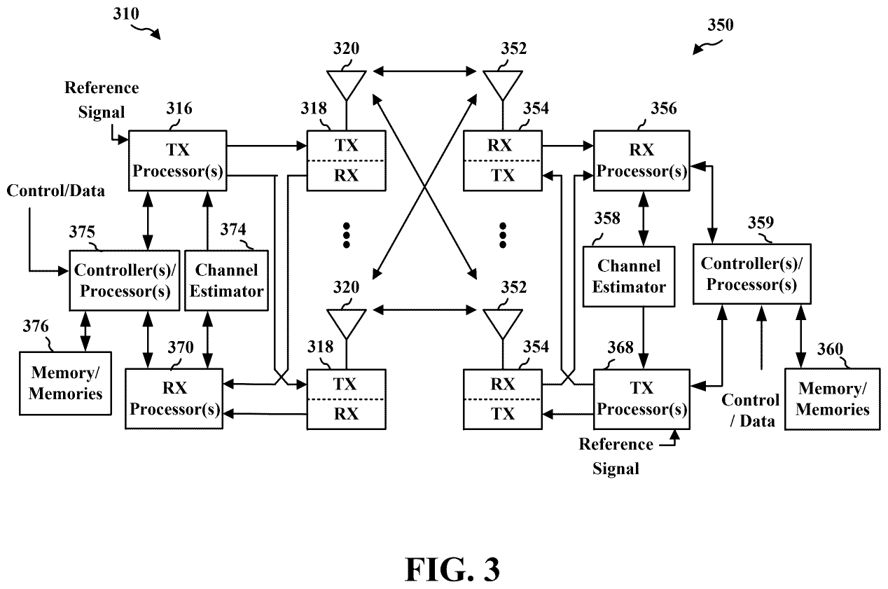

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with configuration update component 198 of FIG. 1A.

In the evolving landscape of 5G networks, energy efficiency is a key area of focus. One of the strategies being explored to achieve this is on-demand operations. For instance, a synchronization signal block (SSB) of a secondary cell (Scell) for a UE in a radio resource control (RRC) connected state with carrier aggregation (CA) may be operated on-demand. Thus, instead of the SSB being continuously active, it is triggered when needed, leading to potential energy savings.

The triggering of these on-demand operations may be achieved through various methods. One such method is an uplink (UL) wake-up signal, a signal sent from the UE to the network indicating that it is active and ready to receive data. Another method may be through cell on or off indications via the backhaul, the connection between the base station and the network core. Yet another method may be through Scell activation or deactivation signaling, which involves signals used to activate or deactivate a Scell. Similarly, the system information block type 1 (SIB1), which contains important information for the UE to communicate with the network, may also be made available on-demand for UEs in RRC idle or inactive states. The configuration of the wake-up signal, which does not involve any changes to the SSB, is another area of focus. Information exchange between base stations is considered for this configuration, particularly to coordinate the timing of the wake-up signal to avoid interference.

Adaptation of signal and channel transmissions is another strategy being explored for energy savings. This includes adaptations in the time-domain for the SSB and the physical random access channel (PRACH), which is used by the UE to make initial contact with the network. The adaptation in the time-domain may involve, for example, adjusting the timing of the signals to optimize the use of the spectrum. For instance, an SSB or physical broadcast channel (PBCH) periodicity, or a timing of some other common signal or channel, may be adjusted dynamically or semi-statically. Additionally, the adaptation of PRACH in the spatial domain is being studied. This may involve adjusting the direction and shape of a signal beam associated with a PRACH occasion to avoid interference, for example. The adaptation of paging occasions, times when the network sends a paging message to the UE to notify it of incoming data, is also part of this strategy. For example, a number of transmitted or monitored PRACH occasions or paging occasions may be reduced or confined to a shorter amount of time, allowing the network to enter longer sleep states and achieve more energy savings.

Paging is a process used by the network to notify a UE of incoming data or signaling messages. The network may page the UE in case of, for instance, a system information update or the reception of downlink signaling. Thus, if the network intends to transmit some downlink signaling to the UE, it will initiate paging. The UE monitors a paging channel during a paging occasion (PO) per discontinuous reception (DRX) cycle. The DRX cycle is a period during which the UE alternates between awake and sleep states to save power. The default DRX period is broadcasted in system information (SI), but a UE-specific period for DRX may be configured through non-access stratum (NAS) signaling or RRC signaling. The UE, when in idle mode, may wake up at a specific time in the DRX period to measure an SSB to maintain time and frequency synchronization. After this, the UE may wait for its specific paging frame. If there is no paging, the UE may go back to sleep. If the UE detects the paging, it will perform initial access, changing its status to RRC connected. Once it is in RRC connected status, the network may schedule the downlink signaling.

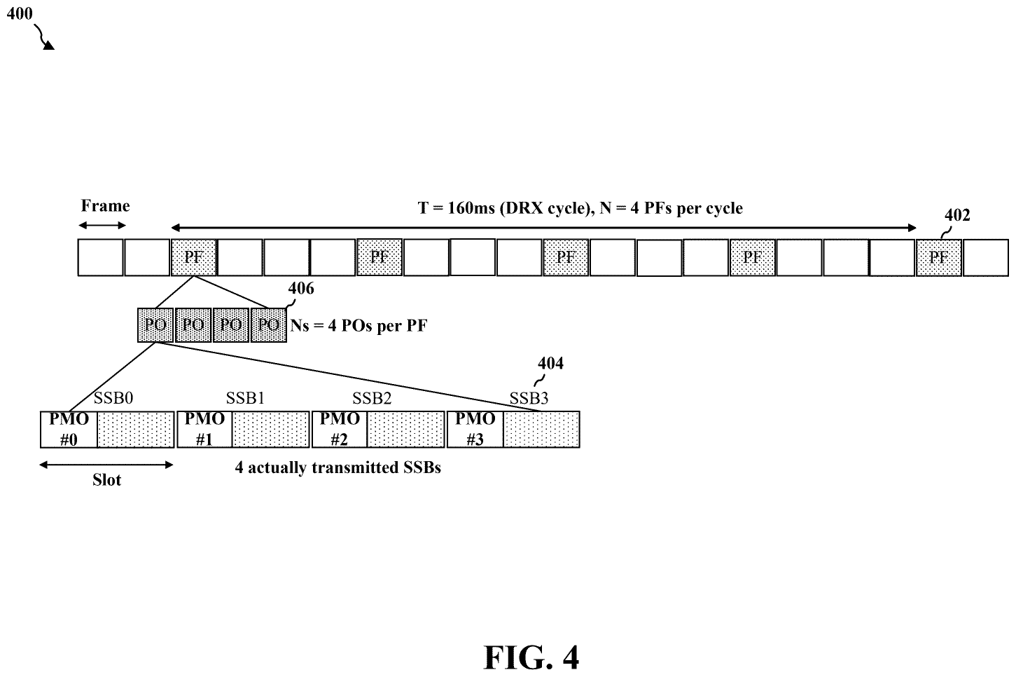

FIG. 4 provides an example 400 of paging frames 402 that include SSBs 404 and POs 406. Paging frames 402 are part of the cycles determined by system information. In this example, there are four paging frames that are uniformly spaced within a 160 ms DRX cycle or paging cycle, although different numbers of paging frames 402 or cycle timings may be configured in other examples. Within each paging frame 402, there are paging occasions or POs 406. The number of POs 406 in a paging frame may be determined by a parameter Ns, which in this example is four but may alternatively be a different number given by system information. Within each paging occasion, there may be multiple paging monitoring occasions (PMOs). Each of these PMOs corresponds to a different one of the SSBs 404. The equation for determining a timing of one of the POs 406 may be as follows:

For the System Frame Number (SFN) for paging frame (PF):

$$( S F N + P {F}_{offset} ) mod T = \frac{T}{N} ( UEID mod N ) ,$$

For the PO index:

$$PO index : {i}_{s} = floor ( \frac{UEID}{N} ) mod {N}_{s} .$$

Here, SFN is a System Frame Number, PF_offset is an offset for the paging frame, T is a total number of frames, N is a number of UEs, UEID is a user equipment identifier, and N_s is the number of paging occasions.

In the above example, the UE may wake up to measure the SSB 404 for one of the paging frames 402, even if the network is not going to send paging in PO 406. To address this inefficiency, PEI was introduced. The early indication allows the UE to ascertain in advance if there will be paging. This can help to save energy by reducing unnecessary wake-ups, thereby improving the energy efficiency of the network.

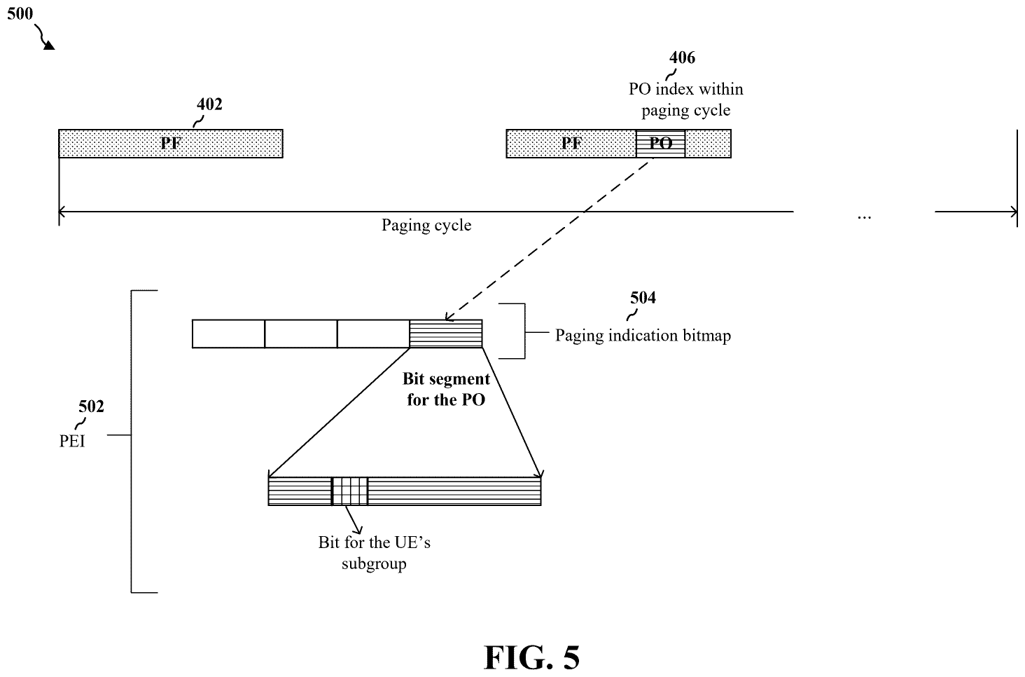

FIG. 5 illustrates an example 500 of paging frames 402 that include POs 406 indicated in a PEI 502. The PEI 502 indicates a certain number of POs, referred to as POnumPerPEI, in one or two consecutive paging frames (PFs). The value range of POnumPerPEI may be {1, 2, 4, 8} in one example, indicating respectively 1, 2, 4, or 8 POs, although the value range may be different in other examples. POnumPerPEI is a factor of the total number of POs in a paging cycle. Thus, the total number of POs 406 in a paging cycle may be a multiple of POnumPerPEI.

The value of POnumPerPEI, which is the number of POs 406 indicated by the PEI 502, may be smaller than the number of POs 406 per PF, denoted as N_s. However, when POnumPerPEI is larger than N_s, it may be a multiple of N_s. This ensures that the number of POs 406 indicated by the PEI 502 aligns with the number of POs per PF.

The PEI 502 also includes a paging indication bitmap 504. This bitmap 504 has POnumPerPEI bit segment(s), each of K bits. The value of K may be equal to subgroupsNumPerPO if subgrouping is configured, otherwise K may be equal to 1. Subgrouping refers to the division of UEs into subgroups for more efficient signaling. Thus, instead of signaling all UEs at once, the network may signal specific subgroups of UEs in PEI 502, which may help to manage the communication load and ensure more efficient use of the network resources. The size of the bitmap 504 in the PEI 502 may thus be POnumPerPEI×subgroupsNumPerPO if subgrouping is configured. If subgrouping is not configured, the size of the bitmap may be equal to POnumPerPEI.

The UE 104, 350 determines the index of its associated bit segment in bitmap 504 based on the PO index within the paging cycle. The PO index is consecutively counted for POs 406 across all PFs 402 in the paging cycle. The UE maps the PO index across all PFs 402 to a bit segment based on the relative PO index within the bitmap 504. This PO index may be calculated using the following formula:

$$i\_PO = ( ( UE\_IDmodN ) \times N\_s + i\_s ) mod POnumPerPEI ,$$

where N is the total number of paging frames in the paging cycle, N_s is the index of the PO 406 within the paging frame 402, and POnumPerPEI is the number of POs 406 indicated by the PEI 502.

If subgrouping is configured, within the bit segment of bitmap 504, the bit that is used as the paging indication for the UE's subgroup is determined by the UE's subgroup index i_SG. This is represented by the bit i_PO×K+i_SG of the paging indication bitmap 504, where K may be equal to subgroupsNumPerPO if subgrouping is configured, otherwise K may be equal to 1. The value of the bit determines whether the UE processes the paging DCI in PO 406. If the bit value is 1, the UE processes the paging DCI. If the bit value is 0, the UE does not process the paging DCI. This allows the network to control which UEs process the paging DCI, which may save energy by reducing unnecessary operations.

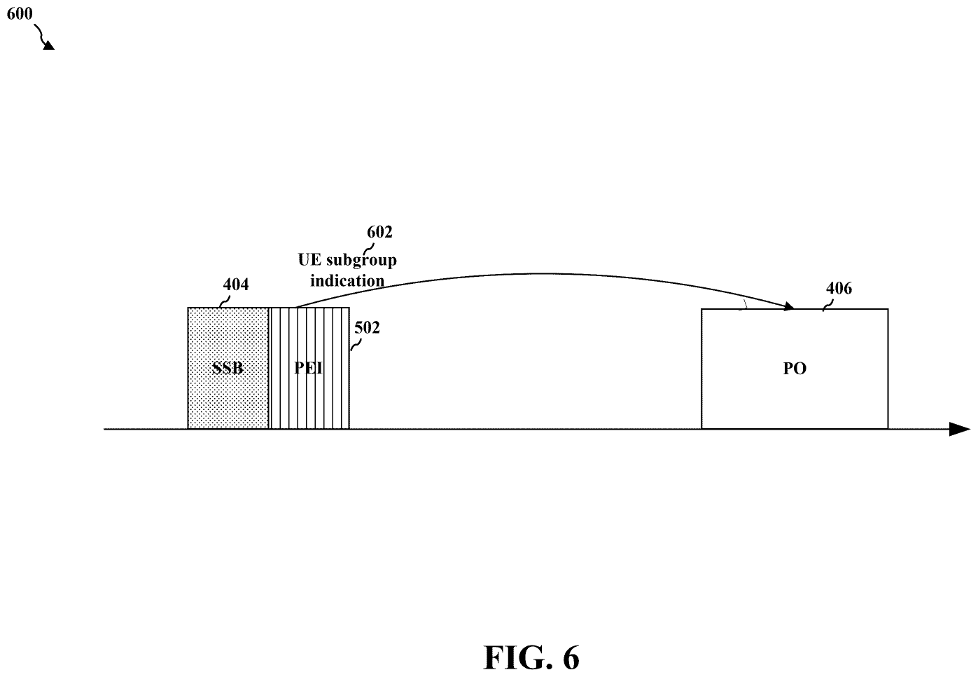

FIG. 6 illustrates an example 600 of an indication 602 in PEI 502 of the PO 406 for a subgroup of UEs 104, 350. The PEI 502 may be transmitted immediately after SSB 404. The UE wakes up to measure the SSB 404 and receives the PEI 502. If the PEI 502 informs the UE that it will receive paging, then the UE may wake up again to receive the paging in PO 406. However, if the PEI 502 informs the UE that it will not receive paging, then the UE does not wake up again and may return to sleep until the next paging cycle. By waking up only when there is an indication to receive paging, the UE may conserve energy, thereby improving the overall energy efficiency of the network.

Thus, in one example of paging, the base station 102/180, 310 may transmit SSB 404 indicating a PO 406 of the UE 104, 350 or a subgroup of UEs. If the UE is in idle mode and there is an incoming call for it, the network may then send PEI 502 in the DCI 2_7 format to alert the UE of an upcoming paging occasion. The UE may then monitor the paging channel during the indicated PO. When the UE receives a paging indication in the DCI of a PDCCH, it may determine that there is a paging message for it. The network may then send the paging message on the PCCH, which is located within the same PO, and the UE may establish a connection with the network to receive the call.

In the given example 600, different UEs 104, 350 may receive paging at different times. The PEI 502 may inform UEs about the paging frames 402 in the cycle. The PEI 502 may provide information about up to two paging frames and up to eight paging occasions in a cycle. The PEI 502 may provide advance notice to multiple UEs about when they will need to wake up to receive paging. By providing advance notice to the UEs, the PEI 502 allows them to stay in sleep mode until they need to wake up to receive paging.

Thus, for network energy efficiency, it would be helpful to indicate adaptations of common signals and channels via paging, rather than through on-demand SIB1 for example. For instance, the paging may indicate information about the adaptation or the adaptation itself. The signaling of such adaptations may be indicated either through the PEI 502 or through the PO 406. For instance, the PEI 502 may contain information about adapting the SSBs 404, PRACH, or even the POs 406 themselves. Alternatively, the DCI in the PO 406, which is part of the PF 402, may contain this information. However, each method has its limitations.

For instance, the PO 406 has the capacity to carry payload, and thus it may carry adaptation information for a common signal or channel along with the indication of the adaptation. However, as there may be multiple POs 406 for the network to indicate such adaptation, it may end up sending an adaptation indication in every paging occasion. Moreover, if the network adapts a common signal or channel and relies on DCI of the paging to indicate the adaptation information, it may adapt it for multiple UEs in numerous POs 406. Thus, the network may end up transmitting this indication in every paging occasion and in every paging frame, leading to excessive signaling. This may potentially consume a lot of energy, especially in a large network with many UEs.

An alternative is to include the adaptation information in the PEI 502 itself, which may save some signaling. For instance, the PEI 502 may group the UEs, and the base station may send the same adaptation information to multiple UEs at once. However, the PEI 502 does not have a payload, so it cannot carry a lot of information. For instance, the reserved bits in the PEI 502 are small and might not be sufficient to convey this information. This limits the amount of detail that may be communicated about the adaptation in the PEI.

Accordingly, to provide for efficient and effective signaling of common signal and channel adaptation in a cellular network without causing excessive signaling or running out of bits in the early indication, aspects of the present disclosure provide for PEIs 502 to be applied to indicate the adaptation of SSBs 404 or other common signals or channels, while the information regarding the adaption itself may be sent in a given one or more of the POs 406. By leveraging the group signaling capability of PEI 502 with the payload carrying capability of POs 406, a more energy-efficient way to signal adaptations in the network may be achieved. For example, multiple UEs 104, 350 may be indicated in the PEI 502 to monitor a single PO such as PO 406 for the adaptation information for SSB 404, and thus the network does not need to transmit this adaptation in every single PO, thereby saving network energy. While the following aspects consider adaptations for SSB, PRACH, and paging channels, it should be understood the adaptations may apply to other common signals or channels, such as adaptation of SIB1 periodicity or other parameters.

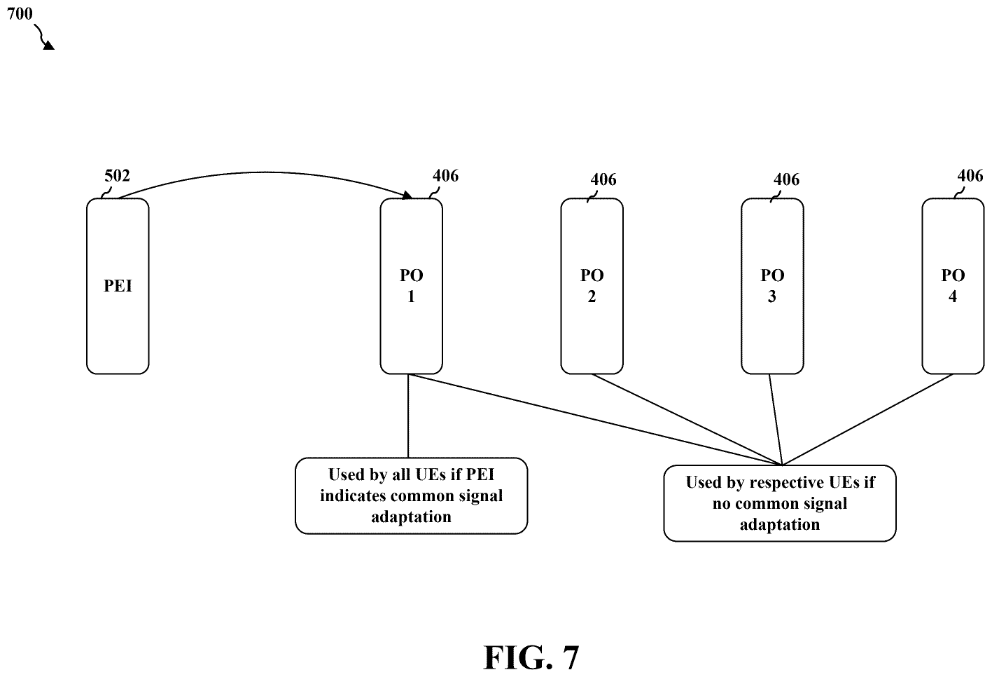

FIG. 7 illustrates an example 700 of PEI 502 that is applied to inform UEs 104, 350 associated with POs 406 about upcoming adaptations in common signals and channels. In this example, there are four POs 406 associated with PEI, although this quantity may be different in other examples. Besides indicating in the PEI 502 whether or not a UE is to monitor its respective PO 406 for paging, an extra bit, field, or other information may be added here to the PEI 502 that indicates whether or not there is a common signal and channel adaptation. This bit or other information does not specify what type of adaptation would happen (the adaptation information), just whether an adaptation is going to occur (the adaptation indication). For example, PEI 502 may indicate through bitmap 504 which POs 406 the UE 104, 350 is going to monitor, and may include another bit indicating whether or not there is an adaptation for SSB 404 in these PO(s) 406 or other PO(s).

To obtain the details of this adaptation or the adaptation information, the UEs may be configured, indicated, or determine to monitor the first paging occasion PO1, which may to be the only paging occasion that carries the adaptation information in this example 700. Alternatively in other examples, PO2, PO3, or PO4 may be configured, indicated, or determined to carry the adaptation information. The PO including the adaptation information may be explicitly indicated in system information, explicitly indicated in PEI, or implicitly indicated in the PO the UE is to monitor for paging. Thus, the network does not need to signal this adaptation in all paging occasions, only in one of them, such as PO1 in this example. Moreover, the UE may monitor other POs for paging messages than the POs indicating the adaptation details. For example, the UE may monitor both the first PO for the adaptation information and the second PO for a paging message, if the PEI indicates a paging indication for that UE is in the second PO for example.

Accordingly, in one aspect of the present disclosure, as described for instance with respect to example 700 of FIG. 7, the PEI 502 may carry an indication of common signal or channel adaptation to be carried in the PO 406. This aspect may be expanded such that PEI 502 indicates more than just the adaptation of an SSB, PRACH, or PO, such as system information updates in general. Thus, the PEI may provide detailed updates on any signal or channel common to or used by multiple UEs. For instance, details of SSB adaptations, PRACH adaptations, and paging adaptations may be indicated through paging. These updates or adaptations may also be distributed across the PEI 502 and the POs 406. For example, adaptation information may potentially be indicated in either the PEI 502 or the POs 406. The exact PO 406 that may carry the common signal or channel adaptation may be determined in multiple ways.

In one approach for indicating which paging occasion will carry the common signal or channel adaptation, the PO 406 may be part of the system information related to PEI 502 or a paging indication (a DCI in PO 406) that is given to the UE. For instance, the first available PO1 indicated by the PEI 502 in FIG. 7 may be used for this purpose. More particularly, multiple UEs 104, 350 may monitor this PEI 502, and if the PEI 502 indicates a system information update, then the first paging occasion PO1 may carry this update, or the second paging occasion PO2 may carry this update, or whichever PO is indicated in the system information. For instance, in the PEI configuration, there may be a parameter that informs the UE in the event of a system information update, whether the adaptation information is to be indicated in the first, second, third, or fourth paging occasion illustrated in FIG. 7. This parameter or a different parameter may also indicate which paging frame 402 includes the adaptation information, as PEI 502 may span up to two paging frames and each paging frame can contain up to eight paging occasions as previously described.

In another approach for indicating which paging occasion may carry the common signal channel adaptation, the PO 406 may be indicated in the PEI 502 itself. For example, the PEI 502 may indicate an index of the PO 406 in which the adaptation may be signaled. Thus, the PEI 502 may inform the UE 104, 350 exactly which PO is going to carry this update information. Alternatively, the PEI 502 may indicate a bitmap of multiple POs that may carry such adaptation such as bitmap 504. For instance, the PEI 502 may not merely indicate one PO 406 for the adaptation, but multiple. As an example, if the bitmap 504 indicates ‘1100’, the UE may determine the system information updates are going to be transmitted in the first two paging occasions PO1 and PO2 of FIG. 7 but not in in a latter two paging occasions PO3 and PO4.

In a further approach for indicating which paging occasion will carry the common signal channel adaptation, there may be an implicit rule that the updated configuration is carried in one or all of the POs 406 for which there is already a paging. As previously described, the PEI 502 may inform the UE 104, 350 if there will be paging in a given paging occasion or not. If the PEI 502 indicates for a particular UE group or subgroup that there will be paging in certain PO(s) 406, then the UEs in this group or subgroup may monitor the PO(s) 406 for both the paging and the adaptation information.

In one example, the UE 104, 350 may check the PEI 502 payload to determine if there is an adaptation indication and which POs 406 are indicated to have paging. The UE may receive the PEI 502, even though the PEI is not indicating the UE 104, 350 to wake up for this paging, if the PEI 502 indicates an adaptation. The UE may then determine what other UEs are being indicated to wake up to receive paging, and then the UE may monitor this PO 406 to receive the adaptation information for the common signals and channels. If there are multiple paging attempts, for example, if the network is asking multiple groups of UEs associated with POs 406 to wake up to receive paging, then there may be a rule that the adaptation information is either going to be sent in the multiple associated POs or in one of these POs.

Thus, if there is at least one PO 406 with paging, then the network may send the update indication in the same PO as indicated for the paging. That is, if paging is to occur and it is indicated in PEI 502 that there will be an adaptation of the common signals and channels, then the adaptation will be indicated in the same PO used for the paging. Thus, the base station may avoid sending another paging occasion just for the common signal and channel adaptation, and instead include it with the one that is going to be transmitted with a paging message. Alternatively, if the PEI 502 does not indicate any paging, then the UE 104, 350 may fallback to either system information or PEI to determine the PO 406 having the adaptation information such as previously described.

There may be various types of adaptations included in any of the aforementioned indication approaches. For example, the adaptations of common signals or channels indicated in PEI 502 and included in PO(s) 406 may comprise changes to the SSB periodicity, changes to SSB burst position (such as via parameter SSB-PositionsInBurst), changes to PRACH parameters such as the periodicity or the PRACH configuration index, additions of random access channel occasions (ROs), or muting or omitting of ROs. Adaptations may also include parameter changes to the PEI 502, paging frames 402, and paging occasions 406. Some adaptations may also include indication of on-demand SSBs or on-demand SIB1s. For instance, the configuration or set of values for parameters associated with a UE uplink request for an on-demand SSB or SIB1 may be adapted.

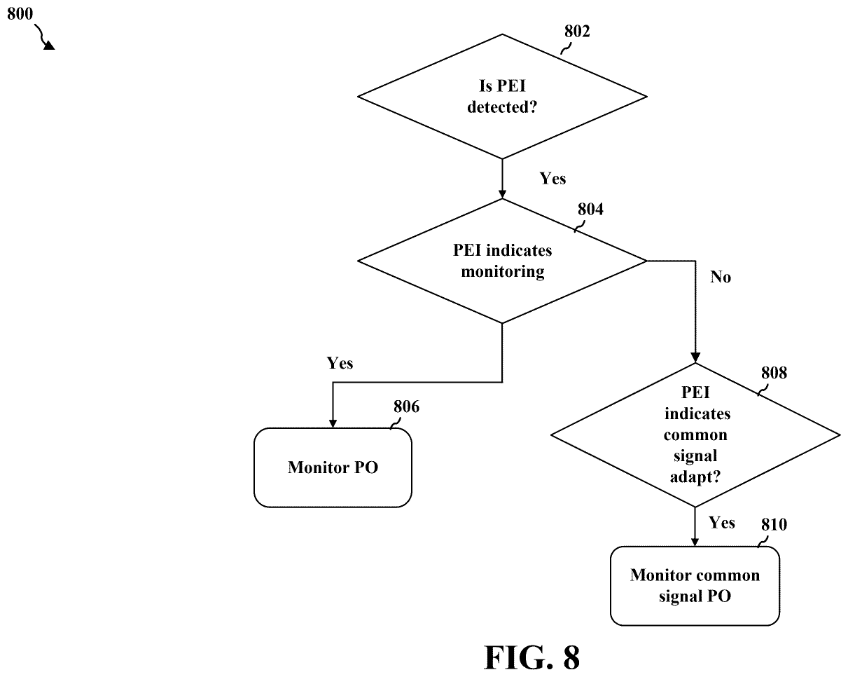

FIG. 8 illustrates an example 800 of UE behavior in response to receiving PEI 502 including an adaptation indication such as described with respect to FIG. 7. Initially, the UE 104, 350 monitors the PEI 502 at block 802. For instance, the UE may actively check for any PEI 502 from the network in a monitoring occasion for the PEI, such as through blind decoding of PDCCH containing DCI including the PEI 502. If the PEI 502 indicates the UE to monitor for a paging indication in a paging frame 402 at block 804, or otherwise that a certain PO associated with the UE's identifier has a paging message, the UE may monitor the corresponding PO 406 for the paging indication at block 806. For example, the UE may check the PO 406 for any paging messages or other signals from the network, such as by performing blind decoding of a PDCCH for a DCI including the paging indication for the paging message. The UE may also determine whether or not there is a common signal or channel adaptation in the monitored PO 406, such as previously described with respect to FIG. 7.

If the PEI 502 indicates skipping or does not indicate the UE to monitor for a paging indication at block 804, the UE's behavior may depend on the common signal or channel adaptation indication. The UE may check this indication to determine its next action at block 808. For instance, if the common signal or channel adaptation indication in the PEI 502 is set to “no adaptation”, or if there is otherwise no common signal or channel adaptation indicated, the UE may skip monitoring the PO. Thus, the UE may not check the PO for any signals from the network, saving energy by not performing this operation. On the other hand, if the common signal or channel adaptation indication in the PEI 502 is set to “adaptation”, or if there is otherwise a common signal or channel adaptation indicated, the UE may monitor the corresponding PO dedicated for common signal or channel adaptation to receive the adaptation and apply it at block 810. For instance, the UE may check the PO 406 for any signals indicating an adaptation of the common signal or channel, and then apply this adaptation to its operation. The PO 406 including the adaptation information may be, for a example, a fixed PO indicated in system information or a PO specifically indicated in the PEI, such as respectively described with respect to FIG. 7. Thus, a dynamic and responsive behavior may be provided for the UE, allowing it to adjust its operation based on the signals it receives from the network. This may lead to more efficient use of resources and energy savings.

To indicate the common signal or channel adaptation for network energy efficiency, the base station 102/180 (the network) may send the indication in the PEI 502 in multiple ways. In one approach, the base station may apply PEI DCI format 2_7 with a different radio network temporary identifier (RNTI) than one applied generally for PEIs 502 (typically a temporary RNTI (T-RNTI)). In this approach, the same PEI may be reused for indicating the adaptation indication, but the UE's interpretation of the PEI 502 would be different based on the RNTI. For example, the base station may reuse the existing DCI payload of the PEI 502 for the adaptation indication and scramble the DCI of the PEI 502 using a dedicated RNTI for this purpose. Thus, by using a different RNTI, the network and UE may distinguish this adaptation PEI from other general paging PEIs. Moreover, in contrast to the aforementioned approaches described with respect to FIGS. 7 and 8 where the PEI payload indicates both the POs having paging messages and whether there is an adaptation or not, here the PEI 502 associated with this different RNTI may not have any information regarding paging occasions with paging messages. That is, this PEI may be dedicated to serve as an adaptation PEI, which in this example may not only indicate presence or absence of the adaptation information, but also whether and which PO(s) include the adaptation information.

In another approach, rather than reusing the PEI DCI 2_7 to indicate the adaptation, a dedicated DCI may be applied for this purpose. For instance, a different format of DCI may be dedicated specifically for the purpose of signaling common signal or channel adaptation information. This DCI format may be distinct from DCI format 2_7 or other DCI formats and may thus be exclusively used to signal the adaptation information. As this dedicated DCI may have a different payload size than PEI DCI 2_7, the PEI 502 in this dedicated DCI may be applied to indicate the POs 406 including paging messages, as well as the adaptation indication itself. Furthermore, the dedicated DCI may include the actual adaptation information, such as the parameters for an SSB periodicity or the like, rather than or in addition to an adaptation indication such as the presence or absence of such adaptation information in PO. Thus, the adaptation information may be wholly transmitted in the PEI, rather than in one part via the PEI 502 and in another part via a POs 406. While this approach may result in more overhead than reusing PEI DCI 2_7, this approach may comparatively reduce signaling latency.

Thus, referring back to block 804 of FIG. 8, the UE 104, 350 may monitor the RNTI of PEI 502 to interpret the fields of the DCI. For instance, the UE may first check if a detected PEI has a T-RNTI. If decoding based on that T-RNTI fails, the UE may attempt to decode the PEI 502 using the different RNTI or based on a different DCI format dedicated for signaling adaptation information. If the DCI including the PEI is decoded with this different adaptation RNTI or DCI format, then the UE may determine that the information sent in this PEI is not about paging but actually about the adaptation of common signals and channels. Thus, the UE may not interpret its payload to indicate monitoring for paging at block 804, but to indicate monitoring for adaptation of common signals or channels, effectively replacing block 804 with block 808. That is, when the UE detects the PEI with that RNTI or dedicated DCI format, it may determine to only monitor for the adaptation, not to look for a paging message as well. The PEI's entire payload may thus be used to indicate the adaptation of common signals and channels.

Accordingly, in the aforementioned aspects, the network does not need to page all UEs 104, 350 in all POs 406 to indicate adaptations of SSBs 404, PRACHs, or other common signals or channels. Instead, the network may send the adaptation information in one PO, and the UEs may monitor that one PO 406 based on the indication in PEI. Alternatively, the network may send the adaptation information in the PEI 502 itself, and the UE may monitor the PEI 502 for the adaptation information. This reduces the number of paging operations the network has to perform, which may save a significant amount of energy. For instance, by configuring the adaptation information in a single PO 406 or the PEI 502, the network may avoid the energy cost of transmitting the same information in multiple POs 406. As a result, these aspects provide a more energy-efficient way for the network to communicate adaptations of common signals or channels to the UEs.

Moreover, the impact of these aspects is minimal on UEs 104, 350 that do not have the capability to decode adaptation indications or information in the PO(s) 406 or PEI 502. For example, when a PEI indicates a UE to skip monitoring a PO for paging, the UE may refrain from monitoring the PO 406, while if the PEI 502 indicates the UE to monitor the PO for paging, the UE may monitor the PO 406 and decode it. In contrast, the reserved bits or other bits in the payload of the PO 406 or the indication or information in PEI 502, which indicate the adaptation indication or information, may be decodable by UEs with capability of monitoring for these indications or information.

It should be understood that while the foregoing described examples of present disclosure aspects are referenced individually or in some cases in alternative form, including but not limited to the examples described with respect to FIGS. 7 and 8, one or more of these aspects or examples may be combined in any combination within the scope of the present disclosure. Similarly, the following referenced aspects or examples may be combined in any combination, notwithstanding any reference to “rather” or “alternatively” in connection with these aspects or examples.

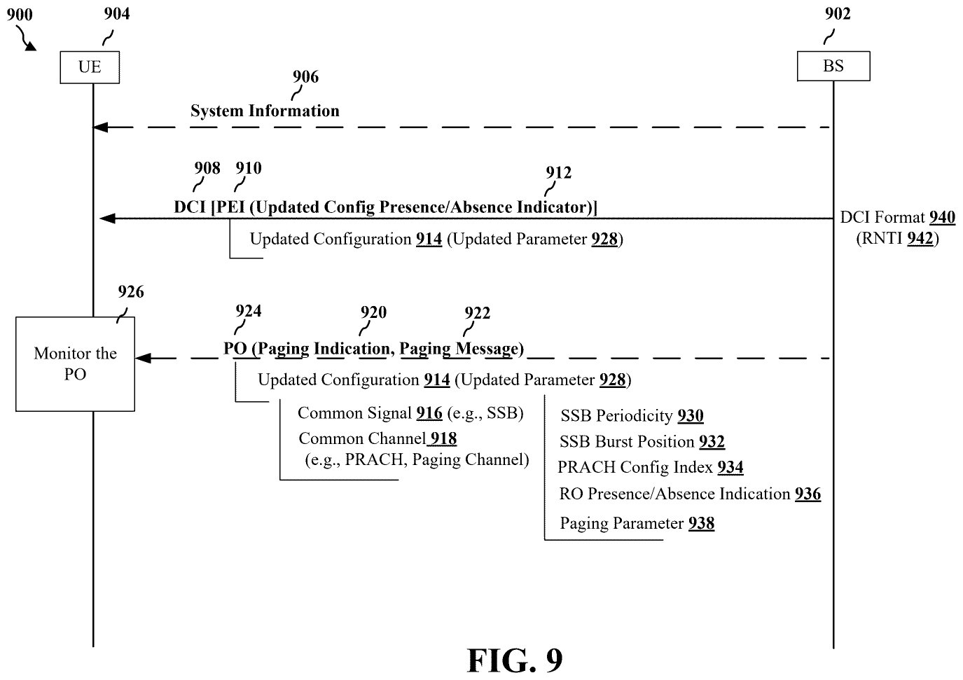

FIG. 9 illustrates an example 900 of a call flow diagram between a base station 902 and a UE 904. Here, base station 902 may correspond to base station 102, 310, and UE 904 may correspond to UE 104, 350.

Initially, the base station may send system information 906 to the UE, and the UE may obtain the system information 906 from the base station. For example, to obtain the system information 906, the UE may receive a signal from the base station, demodulate the signal to extract the system information 906, and then process the information to ascertain the system information 906. This process may involve the UE's receive processor(s) 356 and controller(s)/processor(s) 359, which implement layer 1, layer 2, and layer 3 functionalities as described in FIG. 3. The system information 906 may be associated with a PEI such as PEI 502. For example, the system information 906 may include details about the PEI 502, such as the timing of the PEI, the number of paging occasions indicated by the PEI, and whether there is a common signal or channel adaptation indicated by the PEI. Alternatively or additionally, the system information 906 may be associated with a paging indication in a PO such as a DCI in PO 406. For example, the system information 906 may include details about the PO, such as the timing of the PO, the number of UEs indicated to monitor the PO, and whether there is a common signal or channel adaptation indicated in the PO. In various examples, the system information 906 may be or include details about the network's configuration, such as the SSB periodicity, the PRACH configuration index, and the total number of paging frames in the paging cycle.

After transmitting the system information 906 to the UE, the base station may send a DCI 908 including a PEI 910 to the UE, and the UE may obtain the DCI 908 including the PEI 910 from the base station. The PEI 910 may correspond to PEI 502. For example, to obtain the PEI 910, the UE may receive a signal from the base station, demodulate the signal to extract the DCI 908, and then process the DCI 908 to ascertain the PEI 910. This process may involve the UE's receive processor(s) 356 and controller(s)/processor(s) 359, which implement layer 1, layer 2, and layer 3 functionalities as described in FIG. 3. The PEI 910 may indicate a PO, such as PO 406. For example, the PEI 910 may include a bitmap or other information that indicates which POs the UE is to monitor for paging or for adaptation information. Moreover, the PEI 910 may further include an indication 912 of a presence or absence of an updated configuration 914 for a common signal 916 or a common channel 918. For example, the PEI 910 may include a bit or other information that indicates whether there is an adaptation of the common signal 916 or common channel 918. The common signal 916 may be, for example, an SSB or a SIB-1, while the common channel 918 may be, for example, a PRACH or a PCCH. The indication 912 may allow the UE to determine the presence or absence of the updated configuration 914 for the SSB, SIB-1, PRACH, PCCH, or the like in a PO or the PEI 910. For example, the UE may check the indication 912 in the PEI 910 to determine whether to monitor the indicated PO for the adaptation information.

After transmitting the PEI 910 to the UE, the base station may transmit to the UE, and the UE may receive from the base station, a paging indication 920 and in some cases a paging message 922 in a paging occasion 924. The paging indication 920 may be, for example, a signal or a set of data that informs the UE about the presence of a paging message or about an upcoming change in the network's configuration. The paging message 922 may be, for example, a specific signal or data packet sent from the network to the UE to notify it of incoming data or signaling messages.

At block 926, the UE may monitor the PO 924 based on the PEI 910, and the UE may receive the updated configuration 914 in the PO 924 in response to the monitoring at block 926. For example, the UE may check the PO 924 for any signals indicating an adaptation of the common signal or channel, and then apply this adaptation to its operation. In one example, the UE may first use its receive processor(s) 356 to demodulate the received signal in PO 924. The UE may then extract the PDCCH information from the demodulated signal. After the PDCCH information has been extracted, the UE may then process the information to recover the DCI 908 in the PO 924 including the updated configuration 914. The UE may then decode the updated configuration 914 in the DCI 908. This could involve interpreting the data in the DCI 908 to understand the changes in the network's configuration, such as changes to the SSB periodicity, the PRACH configuration index, or the total number of paging frames in the paging cycle. Here, monitoring based on the PEI 910 may include, for example, the UE checking the PEI 910 for any indications about which POs to monitor for paging or for adaptation information, and whether there is an adaptation of the common signal or channel. This could involve the UE interpreting the data in the PEI 910 to understand when to wake up for paging or to receive adaptation information.

Alternatively, the UE may receive the updated configuration 914 in the PEI 910 in response to the monitoring at block 926. For example, the UE may check the PEI 910 for any signals indicating an adaptation of the common signal or channel, and then apply this adaptation to its operation. This could involve the UE interpreting the data in the PEI 910 to understand the changes in the network's configuration, such as changes to the SSB periodicity, the PRACH configuration index, or the total number of paging frames in the paging cycle.

The updated configuration 914 may include an updated parameter 928 for the common signal 916 such as the SSB or SIB-1 or for the common channel 918 such as PRACH or PCCH. For example, the updated parameter 928 may include a periodicity 930 of an SSB such as SSB 404, a position 932 of the SSB in an SSB burst, a PRACH configuration index 934, an indication 936 of a presence or absence of a RO associated with the PRACH, or a paging parameter 938 associated with the PCCH. For example, the updated parameter 928 could indicate changes to the timing of the SSB or PRACH signals, the position of the SSB in a burst, the configuration of the PRACH, whether a RO is present or absent, or changes to the parameters of the PCCH.

In one example, the paging indication 920 may include the updated configuration 914. For example, the paging indication 920 may include information about the adaptation of common signals or channels, such as changes to the SSB periodicity, the PRACH configuration index, or the total number of paging frames in the paging cycle. This information could be included in the payload of the paging indication 920, allowing the UE to receive the updated configuration 914 along with the paging indication.

In one example, the system information 906 indicates the PO 924 that includes the updated configuration 914. For example, the system information 906 may include a parameter or a set of data that informs the UE about which PO to monitor for the updated configuration. In another example, the PEI 910 indicates one or more POs, such as PO 924, that include the updated configuration 914. For example, the PEI 910 may include a bitmap or other information that indicates which POs the UE is to monitor for the updated configuration. These examples may involve the UE interpreting the data in the system information 906 or the PEI 910 to understand which POs contain the updated configuration, such as PO1 in the example 700 of FIG. 7, thereby guiding the UE to monitor the correct POs for the adaptation information.

In a further example, the PEI 910 indicates inclusion of paging message 922 in the PO 924, and the PO 924 includes the updated configuration 914 based on the inclusion of the paging message 922 in the PO 924. For example, the PEI 910 may include a signal or a set of data that informs the UE that the PO 924 contains a paging message. Based on this information, the UE may then monitor the indicated PO 924, and in the process of receiving the paging message 922, it may also receive the updated configuration 914. Thus, the updated configuration may be transmitted along with the paging message in the same PO, such as PO1 in the example 700 of FIG. 7, allowing the UE to receive both pieces of information in a single operation.

In one example when the updated configuration 914 is transmitted in the PO 924, the UE monitors the PO 924 at block 926 in response to the PEI 910 indicating the UE to monitor the PO for paging message 922 to the UE. For example, the UE may interpret the data in the PEI 910 to determine that it is to monitor the indicated PO 924 for a paging message at block 804 in FIG. 8. In the process of monitoring the PO 924 for the paging message at block 806 of FIG. 8, the UE may also receive the updated configuration 914.

In another example when the updated configuration 914 is transmitted in the PO 924, the UE monitors the PO 924 at block 926 in response to the PEI 910 indicating the UE to skip monitoring of a different PO for paging message 922 to the UE, and in response to the PEI 910 further indicating the presence of the updated configuration 914 for the common signal 916 or the common channel 918 in the PO 924. For example, the UE may interpret the data in the PEI 910 to determine that it does not need to monitor a different PO for a paging message at block 804, but instead may determine to monitor the indicated PO 924 for the updated configuration such as at block 808 of FIG. 8. Thus, the UE may be guided to the correct PO to receive the updated configuration at block 810 of FIG. 8, even though it is not required to monitor that PO for a paging message. This allows the UE to receive the configuration updates without having to perform unnecessary operations.

In one example, the PEI 910 indicates, for each of a plurality of UEs including UE 904, whether paging indication 920 is to be included in at least one of a plurality of POs including the PO 924, and the updated configuration 914 is included in only one of the POs 924 for the plurality of UEs. For example, the PEI 910 may include a bitmap or other information that indicates for each UE in a group, which POs they should monitor for a paging indication. However, the updated configuration 914, which may include information about changes to the network's configuration, is included in only one of these POs. Thus, while each UE in the group may be monitoring different POs for paging indications, they all monitor the same PO to receive the updated configuration, such as PO1 in the example 700 of FIG. 7. This allows the network to communicate the updated configuration to all UEs in the group in a single operation, thereby improving the efficiency of the communication process.

In one example when the updated configuration 914 is received in the PO 924, the PEI 910 indicating the PO 924 is obtained in DCI 908 having a DCI format 940 associated with a RNTI 942, and the RNTI 942 is different than another RNTI associated with other PEIs 502 lacking indication of updated common signal configurations or updated common channel configurations such as configuration 914. For example, the base station may use a different RNTI 942 to distinguish PEIs 910 that include updated configuration information from other PEIs 502 that do not using DCI format 2_7. Thus, when the UE receives a PEI with the RNTI 942, it may determine to interpret the data in the PEI as indicating an updated configuration, and to monitor the indicated PO to receive this configuration. In another example when the updated configuration is received in the PEI 910, the PEI indicating the PO is obtained in DCI 908 dedicated for indication of updated common signal configurations or updated common channel configurations such as configuration 914. For example, the base station may use a dedicated DCI for DCI 908 instead of DCI format 2_7 to transmit PEIs 910 that include updated configuration information. Thus, when the UE receives a PEI in this dedicated DCI, it may determine to interpret the data in the PEI as indicating an updated configuration, and to monitor the indicated PO to receive this configuration. Either example allows the network to communicate updated configuration information to the UE in a way that is distinct from other types of information, thereby improving the clarity and efficiency of the communication process.

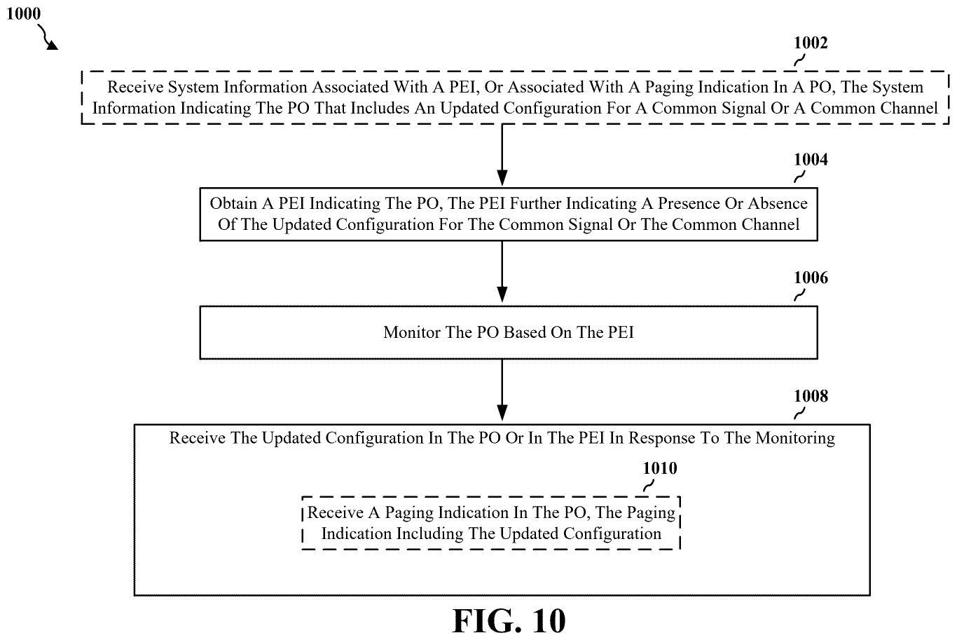

FIG. 10 is a flowchart 1000 of an example method or process for wireless communication. The method may be performed by a UE, such as the UE 104, 350, 904, the apparatus 1102, or its components as described herein. The method allows a UE to efficiently monitor and receive updated configurations for common signals or channels in specific POs based on the indications in PEIs, thereby improving the efficiency of the communication process and saving network energy.

At block 1002, the UE receives system information associated with the PEI, or associated with a paging indication in the PO. For example, block 1002 may be performed by PEI component 1140. For instance, referring to the Figures, the controller(s)/processor(s) 359 or RX processor(s) 356 of UE at block 1002 may receive system information 906 associated with PEI 502, 910 or associated with paging indication 920 in PO 406, 924. For example, the system information 906 may refer in one example to data that provides the UE with details about the overall network's configuration, such as the network's operating frequency, the network's identity, or other parameters that the UE may apply to connect and communicate with the network. The system information 906 may be associated with the PEI or the paging indication 920 in the PO 406, 924 in that the system information 906 may include parameters that guide the UE on how to interpret and respond to the PEI 502, 910 or paging indication 920, such as when and how often to check for the PEI 502, 910 or paging indication 920, or how to interpret the data in the PEI 502, 910 or paging indication 920. The paging indication may refer to a signal sent by the network to indicate that there is a paging message for the UE. The UE monitors for these paging indications during the paging occasions. When it receives a paging indication, the UE ascertains that there is a paging message for it and it establishes a connection with the network. The paging indication may be carried in the DCI of the PDCCH, which may be located in specific resources within the PO.

At block 1004, the UE obtains a PEI indicating a PO. The PEI further indicates a presence or absence of an updated configuration for a common signal or a common channel. For example, block 1004 may be performed by PEI component 1140. For instance, referring to the Figures, the controller(s)/processor(s) 359 or RX processor(s) 356 of UE at block 1004 may receive PEI 502, 910 indicating PO 406, 924. For example, the PEI may include a bitmap or other information that indicates which POs the UE is to monitor for paging or for adaptation information. The UE may interpret this data to determine which PO it should monitor. The controller(s)/processor(s) 359 or RX processor(s) 356 may also process this PEI to determine whether or not updated configuration 914 is present or absent in the PO 406, 924 or the PEI 502, 910 for common signals 916 or common channels 918, such as an adaptation of timing or other parameters for SSB 404, PRACH, or paging. For example, the PEI may include a bit or other information that indicates whether there is an adaptation of the common signal or channel. The UE may check this bit or information to determine whether to monitor the indicated PO for the adaptation information.

In various examples, the common signal may be an SSB, the common channel may be a PRACH or a paging channel, and the updated configuration may include an updated parameter for the SSB, the PRACH, or the paging channel. For example, referring to FIG. 9 and the preceding Figures, the common signal 916 may be SSB 404 or SIB-1 or other signal broadcast or multicast to or from multiple UEs, the common channel 918 may be PRACH or PCCH for use of multiple UEs, and the updated configuration 914 may include updated parameters 928 for the SSB, PRACH, PCCH, or other signal or channel, individually or in any combination. In various examples, the updated parameter may be a periodicity of the SSB, a position of the SSB in an SSB burst, a PRACH configuration index, an indication of a presence or absence of a RO associated with the PRACH, or a paging parameter associated with the paging channel. For example, referring to FIG. 9 and the preceding Figures, the updated parameter 928 may be SSB periodicity 930, SSB burst position 932, PRACH configuration index 934, RO presence or absence indicator 936, paging parameter 938, or a combination of any of the foregoing. For instance, the SSB periodicity 930 may be adjusted to optimize the use of the spectrum, the SSB burst position 932 may be changed to avoid interference, the PRACH configuration index 934 may be updated to improve the efficiency of initial contact with the network, the RO presence or absence indicator 936 may be used to manage the communication load, and the paging parameter 938 may be adjusted to allow the network to enter longer sleep states and achieve more energy savings.

At block 1006, the UE monitors the PO based on the PEI. For example, block 1006 may be performed by monitor component 1142. For instance, referring to the Figures, the controller(s)/processor(s) 359 or RX processor(s) 356 of UE at block 1006 may monitor the PO such as described with respect to blocks 806 or 810 of FIG. 8 and block 926 of FIG. 9. For example, the UE may interpret the data in the PEI to determine which POs it should monitor for paging or for adaptation information. This may involve the UE checking the PEI for any signals indicating which POs to monitor, and then monitoring the indicated POs at the appropriate times. The PO may refer to a specific time when the UE listens for a paging message. The network may schedule these paging occasions based on various factors, including the UE's identity and its power-saving settings. The POs may be indicated in an SSB which is broadcasted by the base station. The SSB may assist the UE to find the specific resources used for more detailed system information, which includes the POs.

At block 1008, the UE receives the updated configuration in the PO or in the PEI in response to the monitoring. For example, block 1008 may be performed by configuration component 1144. For instance, referring to the Figures, the controller(s)/processor(s) 359 or RX processor(s) 356 of UE at block 1008 may receive the updated configuration 914 in either the PO 406, 924 or the PEI 502, 910 in response to the monitoring at block 926. For example, when the updated configuration is received in the PO, the UE may check the indicated PO for any signals indicating an adaptation of the common signal or channel, and then apply this adaptation to its operation. This may involve the UE interpreting the data in the PO to ascertain the changes in the network's configuration, such as changes to the SSB periodicity, the PRACH configuration index, or the total number of paging frames in the paging cycle. Alternatively, when the updated configuration is received in the PEI, the UE may check the PEI for any signals indicating an adaptation of the common signal or channel, and then apply this adaptation to its operation. This may involve the UE interpreting the data in the PEI to determine the changes in the network's configuration, and to monitor the indicated PO to receive this configuration.

In one example, at block 1010, the UE may receive a paging indication in a PO, where the paging indication includes the updated configuration. For example, block 1010 may be performed by monitor component 1142. For instance, referring to the Figures, the controller(s)/processor(s) 359 or RX processor(s) 356 of UE at block 1010 may receive the paging indication 920 in PO 406, 924, and the paging indication 920 may include the updated configuration 914. For example, the UE may check the indicated PO for any signals indicating a paging message, and in the process of receiving the paging indication, it may also receive the updated configuration. This may involve the UE interpreting the data in the paging indication to understand the changes in the network's configuration, such as changes to the SSB periodicity, the PRACH configuration index, or the total number of paging frames in the paging cycle, as well as the paging message. The paging message may refer to the actual message sent by the network to the UE during a paging occasion. This message may contain the data that the network intends to send to the UE, such as an incoming call or message. Once the UE receives the paging message, it may process the data and respond accordingly. The paging message may be sent on the PCCH, which is also located within the same PO as the paging indication.

In one example, the system information indicates the PO that includes the updated configuration. For instance, as described with respect to FIG. 9 and the preceding Figures, system information 906 may indicate the PO 406, 924 that includes updated configuration 914. For example, the system information may include a parameter or a set of data that informs the UE about which PO contains the updated configuration. This may involve the UE interpreting the data in the system information to ascertain which PO it should monitor to receive the updated configuration. Thus, the system information may guide the UE to the correct PO to receive the updated configuration.

In one example, the PEI indicates one or more POs that include the updated configuration. For instance, as described with respect to FIG. 9 and the preceding Figures, the PEI 502, 910 may indicate one or more POs 406, 924 that include the updated configuration 914. For example, the PEI may include a bitmap or other information that indicates which POs contain the updated configuration. This may involve the UE interpreting the data in the PEI to determine which POs it should monitor to receive the updated configuration. Thus, the PEI may guide the UE to the correct PO(s) to receive the updated configuration.

In one example, the PEI indicates inclusion of a paging message in the PO, and the PO includes the updated configuration based on the inclusion of the paging message in the PO. For instance, as described with respect to FIG. 9 and the preceding Figures, the PEI 502, 910 may indicate inclusion of paging message 922 in PO 406, 924, and the PO 406, 924 may include updated configuration 914 based on the inclusion of paging message 922 in the PO 406, 924. For example, the PEI may include a signal or a set of data that informs the UE that the PO contains a paging message. Based on this information, the UE may then monitor the indicated PO for the paging message. In the process of receiving the paging message, the UE may also receive the updated configuration. Thus, the updated configuration may be transmitted along with the paging message in the same PO, allowing the UE to receive both pieces of information in a single operation.

In one example, the updated configuration is received in the PO, and the PO is monitored in response to the PEI indicating the UE to monitor the PO for a paging message to the UE. For instance, as described with respect to FIGS. 8 and 9 and the preceding Figures, the updated configuration 914 may be received in PO 406, 924, and the UE may monitor the PO 406, 924 at block 806, 926 in response to PEI 502, 910 indicating the UE to monitor the PO for paging message 922 to the UE at block 804. For example, the PEI may include a signal or a set of data that informs the UE that the PO contains a paging message. Based on this information, the UE may then monitor the indicated PO for the paging message. In the process of monitoring the PO for the paging message, the UE may also receive the updated configuration.

In one example, the updated configuration is received in the PO, and the PO is monitored in response to the PEI indicating the UE to skip monitoring of a different PO for a paging message to the apparatus, and the PEI further indicating the presence of the updated configuration for the common signal or the common channel in the PO. For instance, as described with respect to FIGS. 8 and 9 and the preceding Figures, the updated configuration 914 may be received in PO 406, 924, and the UE may monitor the PO 406, 924 at block 810, 926 in response to the PEI 502, 910 indicating the UE to refrain from monitoring a different PO for paging message 922 to the UE at block 804, and the PEI 502, 910 further indicating updated configuration 914 for common signal 916 or common channel 918 is present in PO 406, 924 at block 808. For example, the PEI may include a signal or a set of data that informs the UE to skip monitoring a different PO for a paging message, but instead to monitor the indicated PO for the updated configuration. This may involve the UE interpreting the data in the PEI to understand which PO it should monitor to receive the updated configuration, even though it is not required to monitor that PO for a paging message.

In one example, the PEI indicates, for each of a plurality of UEs including the UE, whether a paging indication is to be included in at least one of a plurality of POs including the PO, and the updated configuration is included in only one of the POs for the plurality of UEs. For instance, as described with respect to FIG. 7, 9 and the preceding Figures, the PEI 502, 910 may indicate, for each of multiple UEs 104, 350 including UE 904, whether paging indication 920 is to be included in at least one of multiple POs 406 including PO 924, and the updated configuration 914 may be included in only one of these POs 406 such as PO 924 for these multiple UEs 104, 350, 904. For example, the PEI may include a bitmap or other information that indicates for each UE in a group, which POs they should monitor for a paging indication. However, the updated configuration 914 may be included in only one of these POs. Thus, while each UE in the group may be monitoring different POs for paging indications, they all may monitor the same PO to receive the updated configuration, such as illustrated in the example of FIG. 7. This allows the network to communicate the updated configuration to all UEs in the group in a single operation.

In one example, the updated configuration is received in the PO, the PEI indicating the PO is obtained in DCI having a DCI format associated with a first RNTI, and the first RNTI is different than a second RNTI associated with other PEIs lacking indication of updated common signal configurations or updated common channel configurations. For instance, as described with respect to FIG. 9 and the preceding Figures, where the updated configuration 914 is received in PO 406, 924, the PEI 910 indicating this PO may be obtained in DCI 908 having DCI format 940 such as DCI format 2_7 associated with RNTI 942. This RNTI 942 may be different than another RNTI associated with other PEIs 502 lacking indication of updated configurations 914 to common signals 916 or common channels 918. For example, the base station may use a different RNTI to distinguish PEIs 910 that include updated configuration information from other PEIs 502 that do not. Thus, when the UE receives a PEI with the RNTI 942, it may determine to interpret the data in the PEI as indicating an updated configuration, and to monitor the indicated PO to receive this configuration.

In one example, the updated configuration is received in the PEI, and the PEI indicating the PO is obtained in DCI dedicated for indication of updated common signal configurations or updated common channel configurations. For instance, as described with respect to FIG. 9 and the preceding Figures, where the updated configuration 914 is received in PEI 910, the PEI 910 indicating the PO 406, 924 may be obtained in DCI 908 having DCI format 940 dedicated for indication of updated configurations 914 to common signals 916 or common channels 918. For example, the base station may use a dedicated DCI to transmit PEIs 910 that include updated configuration information. Thus, when the UE receives a PEI in this dedicated DCI 908, it may determine to interpret the data in the PEI as indicating an updated configuration, and to monitor the indicated PO to receive this configuration.

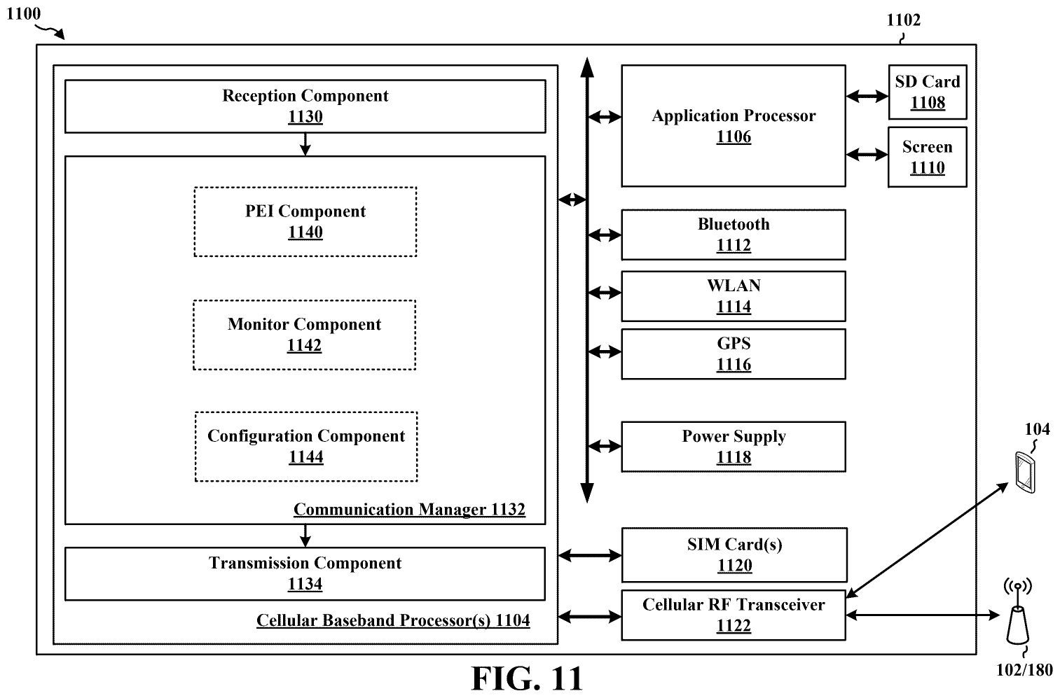

FIG. 11 is a diagram 1100 illustrating an example of a hardware implementation for an apparatus 1102 according to the various aspects of the present disclosure. In one example, the apparatus 1102 may be a UE such as UE 104, 350, 904 and includes one or more cellular baseband processors 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The one or more cellular baseband processors 1104 communicate through the cellular RF transceiver 1122 with the BS 102. For example, the cellular RF transceiver 1122 may correspond to or include the transmitters 354TX, receivers 354RX, and antennas 352 of UE 350.

The one or more cellular baseband processors 1104 may each include a computer-readable medium/one or more memories. The computer-readable medium/one or more memories may be non-transitory. The one or more cellular baseband processors 1104 are responsible for general processing, including the execution of software stored on the computer-readable medium/one or more memories individually or in combination. The software, when executed by the one or more cellular baseband processors 1104, causes the one or more cellular baseband processors 1104 to, individually or in combination, perform the various functions described supra. The computer-readable medium/one or more memories may also be used individually or in combination for storing data that is manipulated by the one or more cellular baseband processors 1104 when executing software. The one or more cellular baseband processors 1104 individually or in combination further include a reception component 1130, a communication manager 1132, and a transmission component 1134. The communication manager 1132 includes the one or more illustrated components. The components within the communication manager 1132 may be stored in the computer-readable medium/one or more memories and/or configured as hardware within the one or more cellular baseband processors 1104. The one or more cellular baseband processors 1104 may be components of the UE 104, 350, 904 and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 1130 may correspond to or include the one or more RX processors 356, the communication manager 1132 may correspond to or include the one or more controllers/processors 359, and the transmission component 1134 may correspond to or include the one or more TX processors 368. In one configuration, the apparatus 1102 may be a modem chip and include just the one or more baseband processors 1104, and in another configuration, the apparatus 1102 may be the entire UE (e.g., UE 350 of FIG. 3) and include the aforediscussed additional modules of the apparatus 1102.

The communication manager 1132 may include a PEI component 1140 that is configured to obtain a PEI indicating a PO, the PEI further indicating a presence or absence of an updated configuration for a common signal or a common channel, such as described in connection with block 1004 of FIG. 10. The PEI component 1140 may also in one configuration be configured to receive system information associated with the PEI, or associated with a paging indication in the PO, such as described in connection with block 1002 of FIG. 10. The communication manager 1132 may also include a monitor component 1142 that is configured to monitor the PO based on the PEI, such as described in connection with block 1006 of FIG. 10. The monitor component 1142 may also in one configuration be configured to receive a paging indication in the PO, such as described in connection with block 1010 of FIG. 10. The communication manager 1132 may also include a configuration component 1144 that is configured to receive the updated configuration in the PO or in the PEI in response to the monitoring, such as described in connection with block 1008 of FIG. 10.

The apparatus may include additional components that perform each of the blocks of the algorithm in the aforementioned flowcharts of FIGS. 9 and 10. As such, each block in the aforementioned flowcharts of FIGS. 9 and 10 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1102, and in particular the one or more cellular baseband processors 1104, includes means for obtaining a PEI indicating a PO, the PEI further indicating a presence or absence of an updated configuration for a common signal or a common channel, means for monitoring the PO based on the PEI, and means for receiving the updated configuration in the PO or in the PEI in response to the monitoring.

The aforementioned means may be one or more of the aforementioned components of the apparatus 1102 configured to perform the functions recited by the aforementioned means. Moreover, as described supra, the apparatus 1102 may include the one or more TX Processors 368, the one or more RX Processors 370, and the one or more controllers/processors 359. As such, in one configuration, the aforementioned means may be at least one of the one or more TX Processors 368, at least one of the one or more RX Processors 356, or at least one of the one or more controllers/processors 359 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain a paging early indication (PEI) indicating a paging occasion (PO), the PEI further indicating a presence or absence of an updated configuration for a common signal or a common channel; monitor the PO based on the PEI; and receive the updated configuration in the PO or in the PEI in response to the monitoring.

Clause 2. The apparatus of clause 1, wherein the one or more processors, individually or in any combination, are operable to cause the apparatus to: receive a paging indication in the PO, the paging indication including the updated configuration.

Clause 3. The apparatus of clause 1 or clause 2, wherein the one or more processors, individually or in any combination, are operable to cause the apparatus to: receive system information associated with the PEI, or associated with a paging indication in the PO, the system information indicating the PO that includes the updated configuration.

Clause 4. The apparatus of any of clauses 1 to 3, wherein the PEI indicates one or more POs that include the updated configuration.

Clause 5. The apparatus of any of clauses 1 to 4, wherein the PEI indicates inclusion of a paging message in the PO, and the PO includes the updated configuration based on the inclusion of the paging message in the PO.

Clause 6. The apparatus of any of clauses 1 to 5, wherein the common signal is a synchronization signal block (SSB), the common channel is a physical random access channel (PRACH) or a paging channel, and the updated configuration includes an updated parameter for the SSB, the PRACH, or the paging channel.

Clause 7. The apparatus of clause 6, wherein the updated parameter is a periodicity of the SSB, a position of the SSB in an SSB burst, a PRACH configuration index, an indication of a presence or absence of a random access channel (RACH) occasion (RO) associated with the PRACH, or a paging parameter associated with the paging channel.

Clause 8. The apparatus of any of clauses 1 to 7, wherein the updated configuration is received in the PO, and the PO is monitored in response to the PEI indicating the apparatus to monitor the PO for a paging message to the apparatus.

Clause 9. The apparatus of any of clauses 1 to 8, wherein the updated configuration is received in the PO, and the PO is monitored in response to: the PEI indicating the apparatus to skip monitoring of a different PO for a paging message to the apparatus, and the PEI further indicating the presence of the updated configuration for the common signal or the common channel in the PO.

Clause 10. The apparatus of any of clauses 1 to 9, wherein the PEI indicates, for each of a plurality of user equipment (UEs) including the apparatus, whether a paging indication is to be included in at least one of a plurality of POs including the PO, and the updated configuration is included in only one of the POs for the plurality of UEs.

Clause 11. The apparatus of any of clauses 1 to 10, wherein the updated configuration is received in the PO, the PEI indicating the PO is obtained in downlink control information (DCI) having a DCI format associated with a first radio network temporary identifier (RNTI), and the first RNTI is different than a second RNTI associated with other PEIs lacking indication of updated common signal configurations or updated common channel configurations.

Clause 12. The apparatus of any of clauses 1 to 11, wherein the updated configuration is received in the PEI, and the PEI indicating the PO is obtained in downlink control information (DCI) dedicated for indication of updated common signal configurations or updated common channel configurations.

Clause 13. A method of wireless communication performable at a user equipment (UE), comprising: obtaining a paging early indication (PEI) indicating a paging occasion (PO), the PEI further indicating a presence or absence of an updated configuration for a common signal or a common channel; monitoring the PO based on the PEI; and receiving the updated configuration in the PO or in the PEI in response to the monitoring.

Clause 14. The method of clause 13, further comprising: receiving a paging indication in the PO, the paging indication including the updated configuration.

Clause 15. The method of clause 13 or clause 14, further comprising: receiving system information associated with the PEI, or associated with a paging indication in the PO, wherein: the system information indicates the PO that includes the updated configuration, the PEI indicates one or more POs that include the updated configuration, or the PEI indicates inclusion of a paging message in the PO, and the PO includes the updated configuration based on the inclusion of the paging message in the PO.

Clause 16. The method of any of clauses 13 to 15, wherein the updated configuration is received in the PO, and the PO is monitored in response to the PEI indicating the UE to monitor the PO for a paging message to the UE.

Clause 17. The method of any of clauses 13 to 16, wherein the updated configuration is received in the PO, and the PO is monitored in response to: the PEI indicating the UE to skip monitoring of a different PO for a paging message to the UE, and the PEI further indicating the presence of the updated configuration for the common signal or the common channel in the PO.

Clause 18. The method of any of clauses 13 to 17, wherein the updated configuration is received in the PO, the PEI indicating the PO is obtained in downlink control information (DCI) having a DCI format associated with a first radio network temporary identifier (RNTI), and the first RNTI is different than a second RNTI associated with other PEIs lacking indication of updated common signal configurations or updated common channel configurations.

Clause 19. The method of any of clauses 13 to 18, wherein the updated configuration is received in the PEI, and the PEI indicating the PO is obtained in downlink control information (DCI) dedicated for indication of updated common signal configurations or updated common channel configurations.

Clause 20. An apparatus for wireless communication, comprising: means for obtaining a paging early indication (PEI) indicating a paging occasion (PO), the PEI further indicating a presence or absence of an updated configuration for a common signal or a common channel; means for monitoring the PO based on the PEI; and means for receiving the updated configuration in the PO or in the PEI in response to the monitoring.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain a paging early indication (PEI) indicating a paging occasion (PO), the PEI further indicating a presence or absence of an updated configuration for a common signal or a common channel;
monitor the PO based on the PEI; and
receive the updated configuration in the PO or in the PEI in response to the monitoring.

2. The apparatus of claim 1, wherein the one or more processors, individually or in any combination, are operable to cause the apparatus to:
receive a paging indication in the PO, the paging indication including the updated configuration.

3. The apparatus of claim 1, wherein the one or more processors, individually or in any combination, are operable to cause the apparatus to:
receive system information associated with the PEI, or associated with a paging indication in the PO, the system information indicating the PO that includes the updated configuration.

4. The apparatus of claim 1, wherein the PEI indicates one or more POs that include the updated configuration.

5. The apparatus of claim 1, wherein the PEI indicates inclusion of a paging message in the PO, and the PO includes the updated configuration based on the inclusion of the paging message in the PO.

6. The apparatus of claim 1, wherein the common signal is a synchronization signal block (SSB), the common channel is a physical random access channel (PRACH) or a paging channel, and the updated configuration includes an updated parameter for the SSB, the PRACH, or the paging channel.

7. The apparatus of claim 6, wherein the updated parameter is a periodicity of the SSB, a position of the SSB in an SSB burst, a PRACH configuration index, an indication of a presence or absence of a random access channel (RACH) occasion (RO) associated with the PRACH, or a paging parameter associated with the paging channel.

8. The apparatus of claim 1, wherein the updated configuration is received in the PO, and the PO is monitored in response to the PEI indicating the apparatus to monitor the PO for a paging message to the apparatus.

9. The apparatus of claim 1, wherein the updated configuration is received in the PO, and the PO is monitored in response to:
the PEI indicating the apparatus to skip monitoring of a different PO for a paging message to the apparatus, and
the PEI further indicating the presence of the updated configuration for the common signal or the common channel in the PO.

10. The apparatus of claim 1, wherein the PEI indicates, for each of a plurality of user equipment (UEs) including the apparatus, whether a paging indication is to be included in at least one of a plurality of POs including the PO, and the updated configuration is included in only one of the POs for the plurality of UEs.

11. The apparatus of claim 1, wherein the updated configuration is received in the PO, the PEI indicating the PO is obtained in downlink control information (DCI) having a DCI format associated with a first radio network temporary identifier (RNTI), and the first RNTI is different than a second RNTI associated with other PEIs lacking indication of updated common signal configurations or updated common channel configurations.

12. The apparatus of claim 1, wherein the updated configuration is received in the PEI, and the PEI indicating the PO is obtained in downlink control information (DCI) dedicated for indication of updated common signal configurations or updated common channel configurations.

13. A method of wireless communication performable at a user equipment (UE), comprising:
obtaining a paging early indication (PEI) indicating a paging occasion (PO), the PEI further indicating a presence or absence of an updated configuration for a common signal or a common channel;
monitoring the PO based on the PEI; and
receiving the updated configuration in the PO or in the PEI in response to the monitoring.

14. The method of claim 13, further comprising:
receiving a paging indication in the PO, the paging indication including the updated configuration.

15. The method of claim 13, further comprising:
receiving system information associated with the PEI, or associated with a paging indication in the PO, wherein:
the system information indicates the PO that includes the updated configuration,
the PEI indicates one or more POs that include the updated configuration, or
the PEI indicates inclusion of a paging message in the PO, and the PO includes the updated configuration based on the inclusion of the paging message in the PO.

16. The method of claim 13, wherein the updated configuration is received in the PO, and the PO is monitored in response to the PEI indicating the UE to monitor the PO for a paging message to the UE.

17. The method of claim 13, wherein the updated configuration is received in the PO, and the PO is monitored in response to:
the PEI indicating the UE to skip monitoring of a different PO for a paging message to the UE, and
the PEI further indicating the presence of the updated configuration for the common signal or the common channel in the PO.

18. The method of claim 13, wherein the updated configuration is received in the PO, the PEI indicating the PO is obtained in downlink control information (DCI) having a DCI format associated with a first radio network temporary identifier (RNTI), and the first RNTI is different than a second RNTI associated with other PEIs lacking indication of updated common signal configurations or updated common channel configurations.

19. The method of claim 13, wherein the updated configuration is received in the PEI, and the PEI indicating the PO is obtained in downlink control information (DCI) dedicated for indication of updated common signal configurations or updated common channel configurations.

20. An apparatus for wireless communication, comprising:
means for obtaining a paging early indication (PEI) indicating a paging occasion (PO), the PEI further indicating a presence or absence of an updated configuration for a common signal or a common channel;
means for monitoring the PO based on the PEI; and
means for receiving the updated configuration in the PO or in the PEI in response to the monitoring.
